(19) United States
(12) Patent Application Publication
(10) Pub. No.: US 2026/0327920 A1
(43) Pub. Date: Oct. 22, 2026

(54) BIODEGRADABLE FILLER FOR ARTIFICIAL GRASS CONTAINING NATURAL MATERIALS WITH ELASTIC PROPERTIES

(71) Applicant: GSK CO., LTD., Hwaseong-si (KR)

(72) Inventor: Bo Jung PARK, Seoul (KR)

(73) Assignee: GSK CO., LTD., Hwaseong-si (KR)

(21) Appl. No.: 19/444,656

(22) Filed: Jan. 9, 2026

(30) Foreign Application Priority Data
Apr. 16, 2025 (KR) 10-2025-0049351

(51) Int. Cl. E01C 13/08; B29C 59/02; C08L 97/02

(52) U.S. Cl. CPC E01C 13/08; B29C 59/02; C08L 97/02; B29C 2059/027; C08L 2201/06

(57) ABSTRACT

A biodegradable filler for artificial grass containing natural materials with elastic properties. The biodegradable filler for artificial grass is obtained from pellets prepared by compressing a mixture of, as minerals, loess and zeolite, with a biodegradable plant-based material and gelatin, to improve the physical strength and elasticity of the filler, to reduce cracking due to frequent use, and to suppress dust. The loess, zeolite, and biodegradable plant-based material can be homogeneously mixed and the homogeneously mixed state can be maintained since gelatin, as a biodegradable material, other than a polymer coating, is incorporated into the pellet. The biodegradable filler can comply with recent environmental regulations on microplastics due to non-use of a separate polymer-based adhesive, and has an antibacterial effect on mold and harmful substances spread between the artificial grass since loess and zeolite are exposed to radiate far-infrared rays.

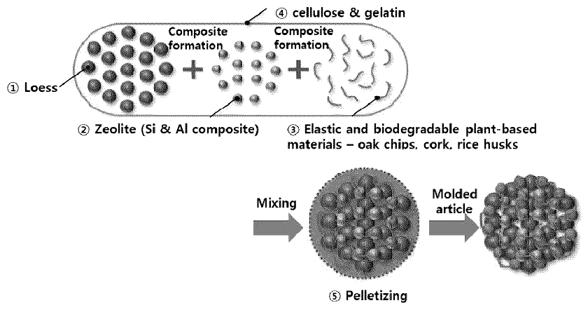

### INCORPORATION OF RELATED APPLICATIONS

This application claims priority from and benefit of Korean Patent Application No. 10-2025-0049351 filed Apr. 16, 2025, of which the entire content is incorporated by reference herein.

### BACKGROUND OF THE INVENTION

### Field of the Invention

The present invention relates to a biodegradable filler for artificial grass containing natural materials with elastic properties.

### Description of the Related Art

Many ball sports are typically played on grass fields. Grass fields typically use natural grass and artificial grass. International hockey rinks in Korea and hockey rinks around the world are made entirely of artificial grass. Artificial grass, which is a synthetic alternative to natural grass that resembles natural grass, is a special type of landscaping material.

Since artificial grass was first produced in the United States, it has been primarily used in sports fields. Artificial grass may also be used in indoor gardens where grass growth is impossible, or in outdoor areas facing the north side of high-rise buildings with extremely limited sunlight. Such artificial grass maintains a perpetually green color and is not affected by environmental conditions and thus is easily maintained after construction. Artificial grass fields may entail higher initial construction costs than natural grass, but are highly preferred due to the semi-permanent use, ease of maintenance, and smooth surface suitable for playing.

The artificial grass field is completed by constructing a shock-absorbing artificial grass structure, forming a layer of silica or sand as a bottom layer to protect the artificial grass, and then applying a filler at a predetermined height.

The filler is selected from a variety of elastic chips. Typically, chips are produced by crushing waste tires and industrial waste rubber, which have high density and elasticity. However, these chips disadvantageously pose environmental problems.

There is a need to develop an environmentally friendly filler that can prevent these environmental issues and suppress cracking over time when used as an artificial grass filler.

### PRIOR ART DOCUMENT

### Patent Document

(Patent Document 1) KR 10-2652204 B1

### SUMMARY OF THE INVENTION

Therefore, the present invention has been made in view of the above problems, and it is one object of the present invention to provide a biodegradable filler for artificial grass containing natural materials with elastic properties.

It is another object of the present invention to provide a biodegradable filler for artificial grass containing natural materials with elastic properties that is prepared by mixing, as minerals, loess and zeolite, with a biodegradable plant-based material and gelatin, compressing the resulting mixture to obtain a pellet, and producing the filler from the pellet to improve the physical strength and elasticity of the filler, to reduce cracking due to frequent use, and to suppress dust.

It is another object of the present invention to provide a biodegradable filler for artificial grass containing natural materials with elastic properties wherein loess, zeolite, and a biodegradable plant-based material can be homogeneously mixed and the homogeneously mixed state can be maintained since gelatin, as a biodegradable material, other than a polymer coating, is incorporated into a pellet, and the biodegradable filler can comply with recent environmental regulations on microplastics due to non-use of a separate polymer-based adhesive, and the biodegradable filler has an antibacterial effect on mold and harmful substances spread between the artificial grass since loess and zeolite are exposed to radiate far-infrared rays, thereby improving the durability of artificial grass.

In accordance with the present invention, the above and other objects can be accomplished by the provision of a biodegradable filler for artificial grass containing natural materials with elastic properties, the biodegradable filler for artificial grass containing a spherical molded chip prepared by homogeneously mixing loess, zeolite, a biodegradable plant-based material, and gelatin, wherein the biodegradable plant-based material is selected from the group of oak chips, cork, rice husks, and a mixture thereof.

In addition, the molded chip may have an average particle diameter of 1 mm to 10 mm.

In addition, the loess may have an average particle diameter of 0.02 mm to 0.05 mm.

In addition, the zeolite may contain silicon and aluminum in a molar ratio of 1.0:1.0 to 1.5:1.0.

In addition, the molded chip may contain the loess and the zeolite in a weight ratio of 4.5:3 to 6.0:0.5.

In addition, the biodegradable plant-based material may contain the oak chips, the cork, and the rice husks in a weight ratio of 5.0:3.0:1.0.

In addition, the molded chip may be prepared by mixing the loess, the zeolite, the biodegradable plant-based material, and the gelatin to form a composite mixture, dissolving the composite mixture at a temperature of 60° C. to 80° C. for 1 hour, forming a pellet at a pressure of 100 MPa to 150 MPa, and grinding upper and lower edges of the pellet to form a spherical shape.

In addition, the gelatin may be mixed with water, and the gelatin and the water may be mixed at a weight ratio of 1.0:100.0.

In addition, the molded chip may further contain cellulose.

In addition, the molded chip may further contain a material selected from the group consisting of bentonite, ball clay, kaolin, and a mixture thereof.

### BRIEF DESCRIPTION OF THE DRAWINGS

The above and other objects, features and other advantages of the present invention will be more clearly understood from the following detailed description taken in conjunction with the accompanying drawings, in which:

The FIGURE is a schematic diagram illustrating a process for producing the artificial grass filler according to the present invention.

### DETAILED DESCRIPTION OF THE INVENTION

Hereinafter, the present disclosure will be described in more detail.

Meanwhile, each description and embodiment disclosed herein may be applied to other descriptions and embodiments as well. That is, all combinations of various elements disclosed herein fall within the scope of the present invention. Furthermore, the specific descriptions provided below should not be construed as limiting the scope of the present invention.

The present invention relates to an eco-friendly and biodegradable material for artificial grass fillers that exhibits enhanced physical strength and elasticity. More specifically, the artificial grass may contain a base layer (aggregate layer), silica sand, a filler, and an artificial grass mat sequentially from the bottom. After all components of the artificial grass have been completely installed, depending on user frequency and environmental conditions, physical deformation may occur, leading to filler abrasion and moisture absorption between artificial grass yarns, which increases the likelihood of presence of harmful substances such as mold and microorganisms. However, conventional fillers typically contain synthetic resins and rubber, which are pulverized into fine particles over time, raising concerns regarding environmental pollution and negative health effects for users.

Specifically, synthetic resins and rubber, when used as fillers for artificial grass, are gradually pulverized into fine powders due to impact during use. This causes release of microplastics, disadvantageously leading to environmental pollution and potentially entering the human body through the respiratory system of users.

To address these issues, the development of a filler for artificial grass is necessary.

The present invention relates to a filler for artificial grass. By combining minerals such as loess and zeolite, with a biodegradable plant-based material, physical strength and elasticity of the filler can be improved. Furthermore, the filler contains eco-friendly gelatin, thereby improving bonding between the loess, zeolite, and the biodegradable plant-based material when molded into pellets, maintaining elasticity, and alleviating cracking of filler depending on frequency of use. Furthermore, the eco-friendly gelatin has an effect of suppressing dust that may be generated by pressure applied to the filler.

Furthermore, the filler according to the present invention is an eco-friendly filler that can overcome recent microplastic environmental regulations using biodegradable materials rather than polymer coatings.

Furthermore, the filler is prepared by compressing a mixture of gelatin rather than coating the entire outer surface of the filler. As a result, when the loess and zeolite are exposed to the outside, they radiate far-infrared rays outside. This causes the filler to exhibit antibacterial activity against mold and other harmful substances that may be present within the artificial grass. This antibacterial activity results in suppression of mold and harmful substances, thereby improving user health and the durability of the artificial grass.

More specifically, the biodegradable filler for artificial grass containing natural materials with elastic properties according to the present invention is a molded chip containing loess, zeolite, a biodegradable plant-based material, and gelatin. The biodegradable plant-based material may be selected from the group consisting of oak chips, cork, rice husks, and mixtures thereof.

The molded chip may have an average diameter of 1 mm to 10 mm. For use as an artificial grass filler, the molded chip should have a spherical shape with an appropriate size. The appropriate average diameter for use as the artificial grass filler is 1 mm to 10 mm.

The loess may have an average particle diameter of 0.02 mm to 0.05 mm and the zeolite may contain silicon and aluminum in a molar ratio of 1.0:1.0 to 1.5:1.0. In addition, the molded chip may contain loess and zeolite in a weight ratio of 4.5:3 to 6.0:0.5, 4.5:3 to 6.0:1.0, or 4.5:1.0. That is, the molded chip may contain loess and zeolite, or may be exclusively composed of loess. The loess and zeolite are contained to enhance the strength of the filler. By mixing loess particles with an appropriate average diameter with zeolite in the weight ratios as defined above, damage that may occur due to external impact can be minimized, thereby preventing formation of fine powders. Furthermore, the filler can exhibit antibacterial properties through the far-infrared radiation generated by the loess.

The biodegradable plant-based material may contain oak chips, cork, and rice husks in a weight ratio of 5.0:3.0:1.0. A combination of the biodegradable plant-based material with the loess and zeolite can enhance physical strength and elasticity when used as an artificial grass filler. Furthermore, this combination is eco-friendly and thus may naturally degrade, thereby preventing environmental pollution.

That is, the loess is present in the form of loess particles, rather than the form of a mixture of clay with water. The zeolite is present in the form of particles. Such mixing of loess with zeolite may create microscopic voids. A filler having these voids may reduce shock absorption due to external pressure, disadvantageously leading to susceptibility to breakage. To prevent this problem, the present invention incorporates oak chips, cork, and rice husks as biodegradable plant-based materials, thereby primarily preventing void formation when mixed with loess and zeolite, and secondly preventing the formation of voids and improving elasticity when mixed with gelatin.

The gelatin may be mixed with water at a weight ratio of 1.0:100.0 and may be present in an amount of 5% with respect to the total weight of the loess and zeolite, as described below. When gelatin is mixed with water within this range, the binding strength of the loess, zeolite, and biodegradable plant-based material can be further enhanced. Furthermore, the filler can absorb external impacts and prevent the molded chips from being finely powdered although the molded chips are damaged by a stronger impact.

The gelatin can prevent the components of the molded chips, i.e., loess, zeolite, and biodegradable plant-based material, from being pulverized by external impacts when used as a filler for artificial grass. Furthermore, the gelatin can prevent cracking and prevent the powdered components from leaking out although the components are powdered. That is, during the manufacturing process of the molded chips, the gelatin is homogeneously mixed with loess, zeolite, and the biodegradable plant-based material. The adhesive effect of the gelatin throughout the molded chips prevents decomposition, cracking, and powdering due to external impact.

This is because the filler not containing gelatin may cause fine powders to detach from the surface of the filler due to collisions between the filler particles or external forces, and these fine powders may easily migrate to the outside. External impacts may cause cracks or damage to the filler, but even minor impacts may cause fine powders to detach from the surface before such cracking or damage occurs.

As mentioned above, these fine powders may cause environmental pollution and even health risks in the human body.

Consequently, according to the present invention, the filler homogeneously contains gelatin, thereby preventing pulverization, cracking, and powdering due to external impact through the adhesive effect.

As described above, the biodegradable filler for artificial grass according to the present invention is a molded chip containing loess, zeolite, the degradable plant material, and gelatin. In addition to the gelatin, the filler may further contain cellulose. The cellulose may be mixed with water in the same weight ratio as the gelatin. When the cellulose is contained along with gelatin, the cellulose may be contained in the same weight ratio as the gelatin, and the gelatin and cellulose may be present in an amount of 5% with respect to the total weight of the loess and zeolite. When the cellulose is contained in an amount within the range defined above, excellent adhesive performance can be achieved. When the cellulose is contained in an amount below this range, the adhesive performance is reduced, leading to potential pulverization or cracking due to external impact. When the cellulose is contained in an amount above the range defined above, excessive amounts of gelatin and cellulose may be present, reducing the elasticity required for use as a filler.

As described above, when the filler further contains cellulose in addition to gelatin, the adhesive performance can be improved and thus the effects of preventing pulverization, cracking, and powdering due to external impact can be further improved, compared to when the filler contains gelatin alone.

Furthermore, the molded chip according to the present invention may further contain a material selected from the group consisting of bentonite, ball clay, kaolin, and a mixture thereof. This material in the molded chip can further enhance elasticity.

The filler for artificial grass according to the present invention exhibits excellent physical strength and elasticity, thus being useful as an alternative to conventional fillers. Furthermore, unlike conventional polymer-based fillers, the filler for artificial grass prevents fine powdering. Furthermore, the filler for artificial grass is composed solely of biodegradable components, thus being easily disposed after the artificial grass and causing no environmental pollution after disposal.

The molded chips may be prepared by mixing loess, zeolite, a biodegradable plant-based material, and gelatin to form a composite mixture. The mixture is dissolved at a temperature of 60° C. to 80° C. for 1 hour and then formed into pellets at a pressure of 100 MPa to 150 MPa. The upper and lower edges of the pellets are ground to form a spherical shape.

To manufacture the molded chips, compression into pellets may be performed. After manufacturing into pellets, gelatin is introduced to prepare a composite mixture in order to increase the adhesiveness of loess, zeolite, and the biodegradable plant-based material. Then, the water introduced to facilitate mixing of the gelatin is removed by drying and the mixture is produced into pellets by compression molding. Compression for 3 hours under the pressure conditions enables preparation into solid pellets without voids. The pellets have an elastic function, thus being used as a filler for artificial grass. Since the pellets do not have a spherical shape, the upper and lower edges are ground to form a spherical shape. The grinding into the spherical shape may be performed by a barrel process, but this process is not limited to the barrel process and any method that can be used to manufacture a spherical filler may be used without limitation.

Hereinafter, embodiments of the present invention will be described in detail so that they can be easily implemented by those skilled in the art. However, the present invention may be implemented in various different forms and is not limited to the embodiments described herein.

### Preparation Example 1

Preparation of biodegradable filler for artificial grass including natural materials with elastic functions

The FIGURE is a schematic diagram illustrating a process for producing the filler for artificial grass according to the present invention.

As shown in the FIGURE, loess and zeolite were prepared at a weight ratio of 4.5:1. A gelatin solution containing gelatin and distilled water at a weight ratio of 1.0:100.0 was prepared in an amount of 5% with respect to the total weight of the loess and zeolite. Oak chips, cork, and rice husks were also mixed at a weight ratio of 5.0:3.0:1.0 and the resulting mixture was prepared in an amount of 10% to 15% with respect to the total weight of the loess and zeolite. Then, the mixture was mixed with the loess, zeolite, and the gelatin solution to prepare a composite composition. The composite composition was dissolved at a temperature of 60° C. to 80° C. for 1 hour. Then, the composite composition was molded at a pressure of 100 to 150 MPa to form a pellet. Then, the upper and lower edges of the pellet were ground using a barrel process to produce a spherical filler.

The loess used herein had an average particle diameter of 0.02 to 0.05 mm, and the zeolite used herein had an average particle diameter of 0.1 to 0.3 mm, with a molar ratio of silicon to aluminum of 1.0:1.0.

### Preparation Example 2

A filler was prepared in the same manner as in Preparation Example 1, except that the molar ratio of silicon to aluminum in zeolite was 1.5:1.0.

### Preparation Example 3

A filler was prepared in the same manner as in Preparation Example 1, except that only loess was used without zeolite.

### Preparation Example 4

A filler was prepared in the same manner as in Preparation Example 1, except that the gelatin solution was not added.

### Preparation Example 5

A filler was prepared in the same manner as in Preparation Example 1, except that the mixture was dissolved at 60° C. to 80° C. for 1 hour without performing the moisture removal step.

### Experimental Example 1

### Determination of Shape of Filler According to Preparation Process

Whether or not the pellets prepared according to Preparation Examples 1 and 5 cracked was determined. More specifically, after production of pellets according to Preparation Examples 1 and 5, the presence of cracks was determined by the naked eye. The experimental results are shown in Table 1 below:

TABLE 1

| | Preparation Example | Preparation Example |
|---|---|---|
| | 1 | 5 |
| Number of cracks | X | O |

The experimental results showed that, in Preparation Example 5, which did not undergo a moisture removal step, most of the pellets cracked or were completely broken during the compression molding process.

In other words, when moisture is not sufficiently removed during the preparation process, cracks will occur during pellet molding, making it impossible to prepare as a filler.

### Experimental Example 2

### Evaluation of Physical Properties of Fillers

The tensile strength, abrasion resistance, and compressive resilience of the fillers prepared according to Preparation Examples 1 to 4 were measured.

The measurement methods will be described in detail below:

### Tensile Strength

Tensile strength was measured using a tensile tester according to ASTM D638.

### Compressive Resilience

A compression tester was used according to ASTM D575. The fillers of Preparation Examples 1 to 4 were placed in a square flask to a height of 10 cm. A load of 0.5 MPa was applied for 1 minute, followed by a 30-second recovery period, as one cycle. This cycle was repeated 100 times and the degree of compression was evaluated. The degree of compression relative to the original height was measured to determine the compressive resilience.

The measurement results are shown in Table 2 below:

TABLE 2

| | Preparation | Preparation | Preparation | Preparation |
|---|---|---|---|---|
| | Example 1 | Example 2 | Example 3 | Example 4 |
| Tensile strength | 53 | 54 | 23 | 12 |
| (MPa) | | | | |
| Compressive | 99 | 99 | 76 | 24 |
| resilience (%) | | | | |

The experimental results showed that Preparation Examples 1 and 2 exhibited excellent tensile strength and Compressive resilience. On the other hand, Preparation Example 3 exhibited excellent compressive resilience, but exhibited tensile strength which was comparable to conventional fillers, but was lower than that of Preparation Examples 1 and 2. Preparation Example 4 exhibited low tensile strength and compressive resilience.

### Experimental Example 3

### Antibacterial Test

An antibacterial test was conducted on the fillers prepared according to Preparation Examples 1 and 2. The antibacterial test was performed by inoculating a test strain into 4 g of a sample dissolved in 100 mL of distilled water, incubating the strain for 24 hours and then measuring the bacterial reduction rate. The details of the antibacterial test are disclosed in KCL-FIR-1002 (2011, “Shaking Flask Method”).

The test was conducted at a temperature of 37.0±0.2° C., and Escherichia coli ATCC 25922 and Pseudomonas aeruginosa ATCC 15442 were used as bacterial strains.

After 24 hours, the bacterial strain reduction rate was evaluated. The bacterial reduction rates were 72% or more and 73% or more, respectively, indicating high levels of antibacterial efficacy. Therefore, the antibacterial properties of the fillers were sufficient to suppress bacterial growth when used as fillers for artificial grass.

As is apparent from the above description, the present invention provides a filler obtained from pellets prepared by compression-molding a mixture of minerals such as loess and zeolite, a biodegradable plant-based material, and gelatin. This filler improves the physical strength and elasticity, and reduces cracking and dust generation due to frequent use.

Furthermore, loess, zeolite, and a biodegradable plant-based material can be homogeneously mixed and the homogeneously mixed state can be maintained since gelatin, as a biodegradable material, other than a polymer coating, is incorporated into a pellet, and the biodegradable filler can comply with recent environmental regulations on microplastics due to non-use of a separate polymer-based adhesive, and the biodegradable filler has an antibacterial effect on mold and harmful substances spread between the artificial grass since loess and zeolite are exposed to radiate far-infrared rays, thereby improving the durability of artificial grass.

Furthermore, the filler according to the present invention is capable of absorbing moisture and releasing stored moisture in the summer season, thereby maintaining the optimal artificial grass field environment in high-temperature environments. This ensures safe use without exposing users to the risk of burns.

Furthermore, conventional natural chips produced from simple materials are light in weight and thus prone to high loss rates during the rainy or monsoon season. However, chips combined with minerals according to the present invention have an increased weight, resulting in a reduced loss rate.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A biodegradable filler for artificial grass containing natural materials with elastic properties,
the biodegradable filler for artificial grass comprising a spherical molded chip prepared by homogeneously mixing loess, zeolite, a biodegradable plant-based material, and gelatin,
wherein the biodegradable plant-based material is selected from the group consisting of oak chips, cork, rice husks, and a mixture thereof.

2. The biodegradable filler for artificial grass according to claim 1, wherein the molded chip has an average particle diameter of 1 mm to 10 mm.

3. The biodegradable filler for artificial grass according to claim 1, wherein the loess has an average particle diameter of 0.02 mm to 0.05 mm.

4. The biodegradable filler for artificial grass according to claim 1, wherein the zeolite comprises silicon and aluminum in a molar ratio of 1.0:1.0 to 1.5:1.0.

5. The biodegradable filler for artificial grass according to claim 1, wherein the molded chip comprises the loess and the zeolite in a weight ratio of 4.5:3 to 6.0:0.5.

6. The biodegradable filler for artificial grass according to claim 1, wherein the biodegradable plant-based material comprises the oak chips, the cork, and the rice husks in a weight ratio of 5.0:3.0:1.0.

7. The biodegradable filler for artificial grass according to claim 1, wherein the molded chip is prepared by mixing the loess, the zeolite, the biodegradable plant-based material, and the gelatin to form a composite mixture, dissolving the composite mixture at a temperature of 60° C. to 80° C. for 1 hour, forming a pellet at a pressure of 100 MPa to 150 MPa, and grinding upper and lower edges of the pellet to form a spherical shape.

8. The biodegradable filler for artificial grass according to claim 7, wherein the gelatin is mixed with water, and
the gelatin and the water are mixed at a weight ratio of 1.0:100.0.

9. The biodegradable filler for artificial grass according to claim 1, wherein the molded chip further comprises cellulose.

10. The biodegradable filler for artificial grass according to claim 1, wherein the molded chip further comprises a material selected from the group consisting of bentonite, ball clay, kaolin, and a mixture thereof.

11. An artificial grass comprising the biodegradable filler for artificial grass according to claim 1.
